(19) United States
(12) Patent Application Publication
(10) Pub. No.: US 2010/0092615 A1
(43) Pub. Date: Apr. 15, 2010

(54) THERMOREGULATING HERBAL BLEND FORMULATION FOR CARBONATED AND NON-CARBONATED BEVERAGES, AND JUICES

(76) Inventor: Jose Angel Olalde Rangel, Clearwater, FL (US)

Correspondence Address: JOSE OLALDE RANGEL, 519 CLEVELAND STREET, SUITE 101, CLEARWATER, FL, 33755, US

(21) Appl. No.: 12/250,752

(22) Filed: Oct. 14, 2008

(51) Int. Cl. A23L 2/02; A23L 2/42

(52) U.S. Cl. 426/66; 426/648; 426/590; 426/599; 426/330.5

(57) ABSTRACT

The invention refers to a herbal blend formulation with thermo regulating properties, consisting of adaptogenic herbal plants as well as bioactive principles that improve adaptative response to thermal stress and providing energy. The herbal blend is a specific formulation for the elaboration of flavored carbonated and non-carbonated beverages and juices.

### PRIOR RELATED APPLICATIONS

Not applicable.

### FEDERALLY SPONSORED RESEARCH STATEMENT

Not applicable.

### REFERENCE TO MICROFICHE APPENDIX

Not applicable.

### FIELD OF THE INVENTION

The invention relates to an herbal blend formulation that may be used in carbonated and non-carbonated colas, drinks, juices and others with the purpose of optimizing heat regulation in the human body. The herbal blend extract formulation is a particular combination of plants that have thermo regulating properties.

### BACKGROUND OF THE INVENTION

The use of beverages and food supplements to cool, rehydrate as well as to provide energy has become pervasive throughout the globe regardless of nation, culture, race, occupation, education or economic background. Thus, there are countless industrial, artisanal, ethnic, scientific or not, ‘tailor’ made, functional, diet, vitamin, power and generic beverages, colas, and waters that claim to invigorate, energize, calm, refresh, cleanse, and beautify among other things. The hype is also shared and made extensive to food supplements (energy bars, yogurts, food supplements etc) and are being used everywhere to dampen human exposure to heat, dehydration and loss of what some manufacturers define as ‘essential’ minerals, vitamins and others. This situation is developing even further as climatic changes due to industrialization and global warming which are affecting human's physical stamina and intellectual performance.

Drink formulations and methods for elaboration have been developed, recent ones are: U.S. Pat. No. 7,205,018; U.S. Pat. No.6,886,887; and U.S. Pat. No. 6,432,929.

### SUMMARY OF THE INVENTION

The herbal blend object of this patent application has been researched and a study has been carried out to test its thermo regulating properties.

The herbal blend formulation's plants have been listed according to their properties.

Thus one embodiment of this invention is to provide an herbal blend formula base which can be used in the elaboration of carbonated or non-carbonated drinks, fruit beverages, and food supplements to compensate the High Temperature Environment to which the human body is submitted.

### DETAILED DESCRIPTION OF THE INVENTION

The following examples are illustrative only and should not serve to unduly limit the invention.

### EXAMPLE 1

### Herbal Blend Design According to High Temperature Environment

High Temperature Environment (HTE) mechanisms were examined for this novel Thermo Regulating extract through Biophysics and Biochemical principles. When an organism is subject to excessive or excess heat, disequilibrium in the total amount of entropy in an open biological system occurs. One of the concepts of entropy is that nature and systems have a tendency to go from order to disorder. Thus, entropy is the measure of disorder. As explained by Erwing Schrödinger's (1933 Physics Nobel Prize winner) equation, the increase or decrease of total entropy in an open biological system is equal to the sum of the internal and external entropy differentials, that is: ΔS=ΔS internal+ΔS exchange.

Therefore, the general change of entropy in an open system is equal to the sum of the internal variations in entropy, and the entropy variations due to the exchange of the system with the environment. The ΔS internal is always greater than 0 (ΔS internal>0) due to catabolic endogenous processes. Therefore, the total equilibrium of the system is only possible when ΔS product of the interchange with the environment is less than 0 (ΔS exchange<0). This last allows the generation of anabolic processes towards the system's equilibrium.

A practical example of this is the following: When an organism is submitted to a high temperature environment (heat), the total system's entropy differential becomes positive, thus it generates an endogenous trend towards biological disorder, and as a consequence a stress condition in the organism. In accordance with Hans Selye's General Adaptation Syndrome, during thermal stress, adaptation reactions occur within the organism at high temperatures, which include the increase in production of suprarenal hormones, such as cortisone, adrenaline, and noradrenalin, and cerebral neurotransmitters, such as dopamine. At the outset, the organism enters in an alarm phase, characterized by the preponderance of the sympathetic system and production of adrenocorticotropic hormones (ACTH), such as adrenalin and noradrenalin, increasing cardiac frequency and glucose and nutrient consumption, leading to mitocondrial Adenosinetriphosphate (ATP) deficiency. This provokes fatigue, suffocation, asphyxia sensation, somnolence and other symptoms derived from energy loss. When this condition is not timely managed the organism falls into a condition denominated Resistance and in which glucocorticoid hormones predominate, characterized by immune system's suppression and trend towards sodium-potassium pump disequilibrium.

The energy metabolism's efficacy is regulated, among others, by the neuroendocrine system's signals as a response to the environments aggressor agents. The excess of heat is one of these adverse conditions. The energy that is referred to herein, is that derived from the tissular cells' oxidative reactions. The energy source determines the organism's functional and metabolic efficacy, whether at the macro or micro cellular level. The ATP is the universal accumulator and energy transporter used by energy dependant metabolic reactions. ATP is contained—in small quantities—in the cells, requiring a constant replenishment. The generation of energy is obtained through glycolysis—conversion of glucose in lactic acid—with the formation of ATP in the cytoplasm; yet more important is the oxidative phosphorylation, that is, the synthesis of ATP from ADP in the mitochondria. All processes stem from the autonomic generation of the Krebs cycle in each cell. The intensity of the energy metabolism is regulated by the neuroendocrine systems' signals, as a response to the environment's aggressor agents.

All body processes use ATP hydrolysis as energy source, including hypothalamus' thermoregulating mechanisms (sweating, faster heart rate and breathing). Additionally, when faced with aggressor impacts (strssors) the organism also uses ATP as an energy source. It's logic to assume that the greater demand and comsumption of ATP requires a rapid replenishment to maintain homeostasis conditions. That is why energizing adapotogens are of great importance as they increase ATP resynthesis (Kustrup et al, 2003; and Bangsbo et al, 2001) thus contributing to the rapid recuperation of the energy levels which use thermoregulating mechanisms.

The adaptogenic eleutherosides contained in the herbal blend extract formulation subject of this patent application optimizes mitochondrial ATP synthesis and resynthesis, stimulating the enzymatic activity which accelerates the tricarboxylic and oxidative phosphorylation cycles. In this way, the efficiency of cellular energy (ATP) production derived from glucose (glycolysis and tricarboxylic acid cycle) and adenosine phosphorylation (oxidative phosphorylation) is increased. The energoceuticals contained in the herbal extract also acquire great importance in adjusting the body to the thermal stress thanks to their adaptogenic property to modulate the heat affected neuro-endocrine system and synchronize it with ATP's low metabolic production. Doing so, they regulate the hypothalamus-hypophysis-suprarenal axis, diminishing adrenaline and noradrenalin production (reducing tachycardia and other adrenergic symptoms) as well as that of cortisol thus allowing the fast restitution of organic equilibrium, energy generation and physical recovery.

### EXAMPLE 2

### Description of Herbal Blend's Components

It has been long recognized that certain herbs which were denominated ‘adaptogens’ are effective in increasing human resistance to heat as well as decreasing the effects of heat in humans. Examples of this are the present applications' herbal components: Eleutherococcus senticosus and Rhodiola rosea.

Eleutherococcus or Acanthopanax senticosus (Russian Ginseng, Siberian Ginseng, Eleuthero, Devil's Shrub, Buisson du Diable, Touch-me-not, Wild Pepper, Shigoka, Acantopanacis senticosus). Contains terpenoids (oleanolic acid), Eleutheroside A (daucosterol); Eleutheroside B (siringin); Eleutheroside B1 (isofraxidin); Eleutheroside B4 (sesamin); Eleutheroside D and E (heteroside siringoresinol); Eleutherosides C, G, I, K, L and M; phytosterols (β-sitosterol), polysaccharides (eleutherans), volatile oils, caffeic acid, coniferyl aldehyde, and sugars. Eleutherococcus, increases energy and vitality levels, improving physical and mental performance, and quality of life. Increases the contribution of oxygen to muscles and allows for longer exercising and faster recovery. Prevents tiredness. The adaptogenic effects of the root of eleutherococcus are produced by metabolic regulation of energy, nucleic acids, and tissular proteins. Eleuthero improves the formation of glucose-6-phosphate. The glucose-6-phosphate oxidizes by the way of pentose, producing substrates for the biosynthesis of nucleic acids and proteins. On the other hand, it increases succinate dehydrogenase and muscular malate dehydrogenase activity, enzymes that intervene in tricarboxylic acids cycle, generating ATP. The eleutherosides B and E are responsible for this adaptogenic activity. Eleutherococcus has antioxidant activity as well as. Russian Ginseng contains at least 40 active ingredients.

Rhodiola rosea (Golden Root, Roseroot, Artic root) consists mainly of phenylpropanoids (rosavin, rosin, rosarin—all specific to R. rosea), phenyl ethanol derivatives (salidroside, rhodioloside, tyrosol), flavonoids (catechins, proanthocyanidins, rodiolin, rodionin, rodiosin, acetylrodalgin, tricin), monoterpenes (rosiridol, rosaridin), triterpenes (daucosterol, beta-sitosterol), and phenolic acids (chlorogenic, caffeic, hydroxycinnamic and gallic acid). There are many species of Rhodiola, but rosavins seem to be unique to R. Rosea, and is the preferred species for the formulation. Rhodiola increases energy levels because it activates ATP synthesis and re-synthesis in mitochondria, stimulating reparative processes after intense exercise. This herbal component provides at least 28 active principles.

### EXAMPLE 3

### Studies that Support Adaptogens' Thermal of Heat Regulating Characteristics

There are several studies which demonstrate various adaptogens'—as well as this extracts' herbal blend components'—thermo regulating capacities. For example:

Berdyshev, V. V. Normalization of the seamen's health status in the tropics by eleutherococcus. In: Adaptation and Adaptogens. Far Easter Book Publishers. Vladivostok, 1977, 119-125.

Farnsworth N R, Kinghorn A D, Soejarto D D, et al. Siberian ginseng (Eleutherococcus senticosus): current status as an adaptogen. Econ Med Plant Res. 1985;1:156-215.

Gagarin, I. A. Eleutherococcus prophylaxis of the disease incidence in the Arctic. In: Adaptation and Adaptogens. The Far Eastern Scientific Center, USSR Academy of Sciences. Vladivostok, 1977, 128).

Kalashnikov, B. N. Effect of eleutherococcus on the disease incidence among miners in the Arctic. In: Abstracts of the Reports Made at the 2nd All-Union Conference on Adaptation of Man to Different Geographical, Climatic and Industrial Conditions. Siberian Branch, USSR Academy of Medical Sciences. Novosibirsk, 1977, 2, 43-44.

Novozhilov G N, Sil'chenko K K. [Mechanism of adaptogenic effect of Eleutherococcus on the human body during thermal stress] Fiziol Cheloveka. 1985;11:303-6.

Afanas'ev B G, Zhestovski\check{i} V A, Mazurov K V, Maevski\check{i} K L. [Comparative evaluation of the effect of Eleutherococcus and an acid-saline beverage on the development of processes of adaptation to intermittent heat effects]. Vopr Pitan. 1973;32:3-9.

Thus the excess of heat is one of the adverse conditions which are successfully countered by the formulation—object of this patent application—and its adaptogenic mechanisms which originate from ATP production increase; therefore, its thermo-regulating capacity.

By use of “herbs” what is meant herein is that the plant (or that portion with heat controlling and/or resistance increase activity) is used whole, ground or as an extract. Also included are purified active ingredients and derivatives thereof.

The following examples are illustrative only and should not serve to unduly limit the invention.

### EXAMPLE 4

### Study on Herbal Blend's Thermoregulating Properties

A study was undertaken to evaluate the present application's herbal blend's capacity to regulate thermal effects in humans.

Name of study: Thermoregulatory effects of novel beverage by Olalde J, Demori R, Tucci D, Magarici M, del Castillo O.

Abstract: A variety of plants have been traditionally used to increase body's resistance to stress. This paved the way for the research and creation of a new herbal extract formulation intended to improve high temperature adaptation, increase heat resistance and improve thermoregulation. Methods: The efficacy of a beverage that combines an herbal blend with Acanthopanax senticosus and Rhodiola rosea, was evaluated through a randomized, double-blind, controlled study, in 20 healthy volunteer adults. Heart and respiratory rate were measured at the beginning and at the end of the test. Subjects were allowed to interrupt the study at any given moment. The endpoint time for each subject was recorded. Results: The study clearly shows a significantly shorter endpoint time span in the control group, compared to the verum group. Positive effects of the herbal extract beverage were confirmed by all tested variables, which registered insignificant changes in heart and respiratory rate in the verum group, compared with the control group. Conclusion This study confirms the thermo regulating properties of the herbal extract beverage, which improves the adaptative response to thermal stress in healthy subjects.

Introduction In accordance with Hans Selye's General Adaptation Syndrome, during thermal stress physiologic adaptative reactions occur within the organism, which depend on the hypothalamus-hypophysis-adrenal axis and are mediated by adrenal hormones and cerebral neurotransmitters, such as cortisol, epinephrine, norepinephrine and dopamine (1). These hormones facilitate immediate physical reactions which include: acceleration of heart beat and respiration, dilation of muscular blood vessels, inhibition of gastrointestinal and sexual functions and others, and psycho-physiologic reactions such as: anxiety, insomnia, irritability, and others (2). It has also been demonstrated that nonlethal heat stress increases levels of heat-shock proteins (Hsps) such as Hsp70 (3). The members of the HSP70 superfamily are universally recognized as cytoprotectants during heat stress and hyperthermia. In the nucleus tractus solitarius, HSP70 levels enhance the sensitivity of sympathetic and parasympathetic arms of the autonomic nervous system to attenuate heat stroke-induced cerebral ischemia and hypotension. (4). A variety of plants have been traditionally used by inhabitants of Russia, China, Korea and Japan, to increase body's resistance to stress (including thermal stress), trauma, anxiety and fatigue. Some of these plants receive the name of adaptogens, defined as plants that produce a nonspecific response in the body—an increase in the power of resistance against multiple stressors including physical, chemical, or biological agents and have a normalizing influence on physiology (5). In the last couple of decades many of their active principles and action mechanisms have been discovered. There is mounting evidence which demonstrates that plants contain active principles which exert their beneficial effects through the additive or synergistic action of their multitude of constituents (6); because of their primary and secondary metabolite roles (7) and the adjuvant substances which enhance the activity of components actually responsible for the effect (8). In order to take the maximum advantage of the benefits of the synergistic action of the active principles in these plants, it is necessary to use them in combination. The synergetic action of herbal combinations on genetic expression has recently been established (9). Herbal formulations have been used for hundreds of years, however, little is known about the methodology to combine plants and obtain effective compositions. The Systemic Theory provided the fundamentals which allowed the formulation of an effective herbal composition. (10-13). The beverage contains a standardized plant extract combination of two adaptogens—Rhodiola rosea and Acanthopanax senticosus. The effects of these adaptogens are mainly associated with the hypothalamic-pituitary-adrenal (HPA) axis and with another part of the stress-system, namely, the sympatho-adrenal-system, which provides a rapid response mechanism mainly to control the acute reaction of the organism to a stressor (14). Acanthopanax senticosus has demonstrable affinity for mineralocorticoid and glucocorticoid receptors (15) and inhibits the corticosterone elevation induced by stress (16); reduces the respiratory quotient, increases the utilization of lipids as energy fuel, reduces heart rate and increases O2 uptake per heart beat (17) and increases cardiac tolerance to the arrhythmogenic action of epinephrine (18). The adaptogenic, cardiopulmonary protective, and central nervous system activities of Rhodiola rosea have been attributed primarily to its ability to influence levels and activity of monoamines and beta-endorphins (19). This adaptogen prevents stress-induced catecholamine release (20), increases cardiac tolerance to the arrhythmogenic action of epinephrine (21) and induces the production of HSP70, cytoprotectants during heat stress and hyperthermia (23, 23). Acanthopanax senticosus and Rhodiola rosea extracts are able to increase stress resistance against a short heat shock as well as chronic heat (24) and exert a strong protective action against a lethal heat shock (25). Acanthopanax improves thermoregulation, reducing heat-induced unfavorable functional shifts of the central nervous system and cardiovascular system. It also promotes an increase in physical and mental working capacity, and improves vision (26). This adaptogen improves the ability to adapt to extreme temperatures (27) while reduces disease incidence (28-30). A comparative evaluation of the effect of Acanthopanax versus an acid-saline beverage showed that this adaptogen improves adaptation to the effects of intermittent heat (31).

Methods: Study design. The study was carried out in 20 adult healthy volunteers. All subjects were informed of the nature and objective of the study, as well as the characteristics of the product. The study's inclusion criteria incorporated subjects consent as a prerequisite for participation. Volunteers were randomly divided into two groups of 10 subjects each, and were exposed to extreme temperatures. In a double blinded manner, Group 1 received four 335 cc bottles of chilled beverage made with the herbal blend object of this application and Group 2 received four 335 ml bottles of a similar flavored chilled beverage, to drink ad libitum. All subjects entered a 72° Celsius dry sauna. Assessments: Heart and respiratory rate were measured at the beginning and at the end of the test. Subjects were allowed to interrupt the study at any given moment. The endpoint time for each subject was recorded.

Baseline cohort characteristics. Baseline cohort characteristics are showed in Table 1.

TABLE 1
General cohort characteristics

| | Value |
|---|---|
| Number of subjects | 20 |
| Age in years | 40 ± 12 |
| Hispanic ethnic group (%) | 100% |
| Number of male | 20 |

Results are depicted in Table 2.

TABLE 2
Results

| | Herbal blend beverage | | Similar beverage | |
|---|---|---|---|---|
| | Baseline | Endpoint | Baseline | Endpoint |
| Mean Heart rate (bpm) | 72 | 82 | 72 | 96 |
| Mean Respiratory rate | 16 | 16 | 16 | 22 |
| (Rpm) | | | | |

| | | |
|---|---|---|
| Mean Endpoint time | 40′ | 25′ |
| (minutes) | | |

Variations. Table 2 clearly shows a significantly shorter endpoint time span in subjects that drank the taste-alike beverage, compared to subjects that drank the beverage of this patent application. Positive effect of combined adaptogen beverage is confirmed by all tested variables, which registered insignificant changes in the thermal regulating beverage group, compared with the subjects that drank the simile beverage.

Safety and Tolerability. No adverse effects were seen in any of the tested subjects.

Results. This study confirms the thermo regulating properties of herbal blend beverage, object of this patent application, improving the adaptative response to thermal stress in healthy subjects.

### REFERENCES

1. Selye H. A Syndrome Produced by Diverse Nocuous Agents. J Neuropsychiatry Clin Neurosci 1998;10:230-231.
2. Gleitman, Henry; Alan J. Fridlund, Daniel Reisberg (2004). Psychology, 6, NY: Norton. ISBN 0-393-97767-6.
3. Kelty J D, Noseworthy P A, Feder M E, Robertson R M, Ramirez J M. Thermal preconditioning and heat-shock protein 72 preserve synaptic transmission during thermal stress. J Neurosci. 2002; 22:RC193.
4. Horowitz M, Robinson S D. Heat shock proteins and the heat shock response during hyperthermia and its modulation by altered physiological conditions. Prog Brain Res. 2007;162:433-46.
5. Winston, David & Maimes, Steven. “Adaptogens: Herbs for Strength, Stamina, and Stress Relief,” Healing Arts Press, 2007.
6. Dalby-Brown L, Barsett H, Landbo A K, et al. 2005. Synergistic antioxidative effects of alkamides, caffeic acid derivatives, and polysaccharide fractions from Echinacea purpurea on in vitro oxidation of human low-density lipoproteins. Agric Food Chem. 53:9413-23.
7. Greenspan H C, Aruoma O I, Arouma O. Could oxidative stress initiate programmed cell death in HIV infection? A role for plant derived metabolites having synergistic antioxidant activity. Chem Biol Interact. 1994; 91:187-97.
8. Gilbert B, Alves L F. Synergy in plant medicines. Curr Med Chem. 2003; 10:13-20.
9. Antoshechkin A., Olalde, J., Magarici M., et al. Analysis of effects of the herbal preparation Circulat on gene expression levels in cultured human fibroblasts. Phytotherapy Research. May 17, 2007. [Epub ahead of print].
10. Olalde Rangel J A. The Systemic Theory of Living Systems and Relevance to CAM: Part I: The Theory. Evid Based Complement Alternat Med. 2005; 2: 13-18.
11. Olalde Rangel J A. The Systemic Theory of Living Systems and Relevance to CAM: The Theory (Part II). Evid Based Complement Alternat Med 2005; 2: 129-137.
12. Olalde Rangel J A. The Systemic Theory of Living Systems and Relevance to CAM: the Theory (Part III). Evid Based Complement Alternat Med. 2005; 2: 267-275.
13. Olalde Rangel J A, Magarici M, Amendola F, del Castillo O. The Systemic Theory of Living Systems. Part IV: Systemic Medicine—The Praxis. Evid Based Complement Alternat Med. 2005; 2: 429-439.
14. Panossian A, Wagner H. Stimulating effect of adaptogens: an overview with particular reference to their efficacy following single dose administration. Phytother Res. 2005;19:819-38.
15. Pearce P T, Zois I, Wynne K N, Funder J W. Panax ginseng and Eleutherococcus senticosus extracts—in vitro studies on binding to steroid receptors. Endocrinol Jpn. 1982; 29:567-73.
16. Kimura Y, Sumiyoshi M. Effects of various Eleutherococcus senticosus cortex on swimming time, natural killer activity and corticosterone level in forced swimming stressed mice. J Ethnopharmacol. 2004;95:447-53.
17. Wu Y, Wang X, Li M, Compbell T C. [Effect of Ciwujia (Radix Acanthopanacis senticosus) preparation on exercise performance under constant endurance load for elderly]. Wei Sheng Yan Jiu. 1998;27:421-4.
18. Maslov L N, Guzarova N V. [Cardioprotective and antiarrhythmic properties of preparations from Leuzea carthamoides, Aralia mandshurica, and Eleutherococcus senticosus] Eksp Klin Farmakol. 2007;70:48-54.
19. Kelly G S. Rhodiola rosea: a possible plant adaptogen. Altern Med Rev. 2001;6:293-302.
20. Maslova L V, Kondrat'ev Blu, Maslov L N, Lishmanov IuB. [The cardioprotective and antiadrenergic activity of an extract of Rhodiola rosea in stress]. Eksp Klin Farmakol. 1994; 57:61-3.
21. Maslov L N, Lishmanov IuB. [Cardioprotective and antiarrhythmic properties of Rhodiola rosea preparations]. Eksp Klin Farmakol. 2007;70:59-67.
22. Lishmanov IuB, Krylatov A V, Maslov L N, Naryzhnaia N V, Zamotrinski\check{i} A V. [Effect of a Rhodiola rosea extract on the level of inducible HSP-70 in the myocardium under stress].
23. Afanas'ev S A, Krylatov A V, Lasukova T V, Lishmanov IuV. [Participation of inducible stress-proteins in realizing the cardioprotective effect of Rhodiola rosea] Biokhimiia. 1996; 61(10):1779-84.
24. Wiegant F A, Surinova S, Ytsma E, Langelaar-Makkinje M, Wikman G, Post J A. Plant adaptogens increase lifespan and stress resistance in C. elegans. Biogerontology. Jun 7, 2008. [Epub ahead of print]
25. Boon-Niermeijer E K, van den Berg A, Wikman G, Wiegant F A. Phyto-adaptogens protect against environmental stress-induced death of embryos from the freshwater snail Lymnaea stagnalis. Phytomedicine. 2000;7:389-99.
26. Berdyshev, V. V. Normalization of the seamen's health status in the tropics by eleutherococcus. In: Adaptation and Adaptogens. Far Easter Book Publishers. Vladivostok, 1977, 119-125.
27. Novozhilov G N, Sil'chenko K K. [Mechanism of adaptogenic effect of Eleutherococcus on the human body during thermal stress] Fiziol Cheloveka. 1985;11:303-6.
28. Gagarin, I. A. Eleutherococcus prophylaxis of the disease incidence in the Arctic. In: Adaptation and Adaptogens. The Far Eastern Scientific Center, USSR Academy of Sciences. Vladivostok, 1977, 128.
29. Kalashnikov, B. N. Effect of eleutherococcus on the disease incidence among miners in the Arctic. In: Abstracts of the Reports Made at the 2nd All-Union Conference on Adaptation of Man to Different Geographical, Climatic and Industrial Conditions. Siberian Branch, USSR Academy of Medical Sciences. Novosibirsk, 1977, 2, 43-44.
30. Farnsworth N R, Kinghorn A D, Soejarto D D, et al. Siberian ginseng (Eleutherococcus senticosus): current status as an adaptogen. Econ Med Plant Res. 1985;1:156-215.

### EXAMPLE 5

### Method for Preparing a 1000 Liter Batch of Carbonated Thermo-Regulating Drink

A food grade beverage, was prepared by a mixture of (i) a 600 liter flavored water-based solution macerated until it reaches 80 degrees celsius; (ii) and a 3.6 kilograms of a herbal blend composed of 65% by weight of Eleutherococcus senticosus and 35% by weight of Rhodiola rosea.

Said drink base and said powder herbal base, will be heated during one hour at a temperature of 80 degrees Celsius with a 2 degree Celsius variation. The temperature range maintained between 78-82 degrees Celsius.

The mixing process is maintained while the temperature is allowed to drop to 35-40 degrees Celsius.

When the 35-40 degree Celsius temperature is reached the mixing is continued and a 20 micron filtration process is initiated.

The heavy ingredients such as preservatives are slowly added while a stirring process is carried out.

The final volume is reached by adding water until the volume of 1000 liters is reached. The stirring process is maintained for an additional 15 minutes.

Since the methods of elaboration of carbonated, non-carbonted beverages and juices are quite similar and known to those familiar with the state of the art, the applicant may include other methods if necessary.

1) A Thermo Regulating herbal blend formulation.

2) The Thermo Regulating herbal blend formulation of claim 1, for the elaboration of carbonated or non-carbonated beverages and juices.

3) The Thermo Regulating herbal blend of claim 1 wherein said formulation contains a combination of High Pressure Liquid Chromatography (HPLC) fingerprinted hydro-alcoholic standard herbal extracts.

4) The herbal blend of claim 3 wherein said blend is an herbal mixture of Eleutherococcus senticosus and Rhodiola rosea.

5) The powder herbal blend of claim 4 wherein it further comprises about 0.60 Kg by weight to about 1 Kg by weight of Eleutherococcus senticosus SE with 13:1 potency, for the elaboration of one thousand liters of a carbonated, or a non-carbonated fruit flavored Thermo Regulating beverage or juice.

6) The powder herbal blend of claim 5 wherein it further comprises about 0.3 Kg by weight to about 0.6 Kg by weight of Rhodiola rosea SE with a 10:1 potency, for the elaboration of one thousand liters of a carbonated, or a non-carbonated fruit flavored Thermo Regulating beverage or juice.

7) The herbal blend of claim 6 wherein said formulation will further comprise bioactive contents such as eleutherosides, rosavins, and salidrosides.

8) The herbal blend of claim 7 wherein said blend will further comprise bioactive contents of about 0.3% by weight to about and 1.5% by weight of eleutherosides.

9) The herbal blend of claim 8 wherein said blend will further comprise bioactive contents of about 0.5% by weight to about 2% by weight of rosavins.

10) The herbal blend of claim 9 wherein said blend will further comprise bioactive contents of about 0.15% by weight to about 1.5% by weight of salidrosides.

11) A method of preparing a Thermo Regulating food grade beverage, comprising a mixture of (i) a flavored water-based solution which might include either a relative low temperature maceration or infusion process; (ii) the herbal blend of claim 10; and (iii) mixing said drink base and said powder herbal blend, wherein the mixing step may be performed at a relatively low or at a relatively high temperature.

12) The method according to claim 11 wherein said relatively low temperature is approximately 15-60 degrees Celsius.

13) The method according to claim 11 wherein said relatively high temperature is approximately 60-100 degrees Celsius.

14) The method according to claim 11 wherein said maceration or infusion process is carried out during between 20 and 100 minutes.

15) The method of claim 11 wherein said flavored-water solution comprises one or more fruit flavors.

16) The method of claim 11 wherein said flavored-water solution comprises one or more fruit juices.

17) The method of claim 11 wherein said flavored-water solution comprises one or more fruit juice concentrates.

18) The method of claim 11 wherein said mixture comprises from about 0.15 g to about 0.70 g of a preservative for every 354 ml of beverage.

19) The method of claim 18, wherein the preservative is benzoic acid or a benzoate compound selected from a group consisting of sodium benzoate, potassium sorbate, magnesium benzoate, citric acid and mixtures thereof.

20) The method of claim 10 wherein said mixture may comprise from about 0.01 meq to about 60 meq of potassium ions supplied from about 0.01 mg to 20,000 mg of potassium salt selected from the group consisting of potassium piccolinate, potassium aspartate, potassium gluconate, potassium ascorbate, potassium benzoate, potassium citrate, potassium pytate, potassium acetate, potassium glutamate, potassium pyruvirate, potassium palmitate, potassium caseinate, dipotassium phosphate, potassium trihydrate and or mixtures thereof.

21) The method according to claim 11 wherein said mixture comprises the further step of carbonating the beverage.

22) The method of claim 11 wherein said mixture is not carbonated.
